(19) United States
(12) Patent Application Publication
(10) Pub. No.: US 2018/0183948 A1
(43) Pub. Date: Jun. 28, 2018

(54) IMAGE COMMUNICATION APPARATUS AND COMMUNICATION SYSTEM

(71) Applicant: Oki Data Corporation, Tokyo (JP)

(72) Inventor: Ayumi TAGUCHI, Tokyo (JP)

(73) Assignee: Oki Data Corporation, Tokyo (JP)

(21) Appl. No.: 15/846,309

(22) Filed: Dec. 19, 2017

(30) Foreign Application Priority Data
Dec. 27, 2016 (JP) 2016-253540

(51) Int. Cl. H04N 1/00; H04N 1/32

(52) U.S. Cl. CPC H04N 1/00225; H04N 1/32074; H04N 1/32122; H04N 2201/006; H04N 2201/3208; H04N 2201/3209; H04N 2201/0094

(57) ABSTRACT

An image communication apparatus includes a transmission information receiver, a document controller, and a document transmitter. The transmission information receiver receives transmission information from a mobile terminal. The transmission information includes registration information of the mobile terminal and an instruction to transmit a document image. The document controller determines one of a document and the document image both corresponding to the registration information, when the transmission information receiver receives the transmission information. The document transmitter transmits one of the document image and a read image of the document, on the basis of the determination made by the document controller.

### CROSS REFERENCE TO RELATED APPLICATIONS

The present application claims priority from Japanese Patent Application No. 2016-253540 filed on Dec. 27, 2016, the entire contents of which are hereby incorporated by reference.

### BACKGROUND

The technology relates to an image communication apparatus and a communication system.

A technique called facsimile manual transmission has been provided as a technique directed to preventing a mistake in transmission of a facsimile and transmitting the facsimile to an intended person. According to such an existing technique, a communication apparatus and a communication system have been proposed that each relay a telephone call between a mobile terminal and a destination apparatus, and transmit, to the destination apparatus, a facsimile of image data formed by an image forming apparatus. The mobile terminal may be, for example but not limited to, an extension unit of the communication apparatus. Such a technique is disclosed in Japanese Unexamined Patent Application Publication No. 2013-207658, for example.

### SUMMARY

In an existing technique that relays a telephone call between a mobile terminal and a destination apparatus, and transmits, to the destination apparatus, a facsimile of image data formed by an image forming apparatus, the destination apparatus is required to be coupled to a telephone. Further, it is difficult to make a telephone call while designating a particular individual, even when the destination apparatus is coupled to the telephone.

It is desirable to provide an image communication apparatus and a communication system that achieve transmission of a desired document image with certainty.

According to one embodiment of the technology, there is provided an image communication apparatus including a transmission information receiver, a document controller, and a document transmitter. The transmission information receiver receives transmission information from a mobile terminal. The transmission information includes registration information of the mobile terminal and an instruction to transmit a document image. The document controller determines one of a document and the document image both corresponding to the registration information, when the transmission information receiver receives the transmission information. The document transmitter transmits one of the document image and a read image of the document, on the basis of the determination made by the document controller.

According to one embodiment of the technology, there is provided a communication system including a mobile terminal and an image communication apparatus. The image communication apparatus includes a transmission information receiver, a document controller, and a document transmitter. The transmission information receiver receives transmission information from the mobile terminal. The transmission information includes registration information of the mobile terminal and an instruction to transmit a document image. The document controller determines one of a document and the document image both corresponding to the registration information, when the transmission information receiver receives the transmission information. The document transmitter transmits one of the document image and a read image of the document, on the basis of the determination made by the document controller.

### BRIEF DESCRIPTION OF DRAWINGS

FIG. 1 is a configuration diagram illustrating an example of an outline of an information communication system according to a first example embodiment of the technology.

FIG. 2 is a block diagram illustrating an example of an internal configuration of a multi-function apparatus according to the first example embodiment.

FIG. 3 is a block diagram illustrating an example of an internal configuration of a mobile terminal according to the first example embodiment.

FIG. 4 is a flowchart illustrating an example of a process flow of the multi-function apparatus according to the first example embodiment.

FIG. 5 is a flowchart illustrating an example of a process flow of the multi-function apparatus subsequent to the process flow illustrated in FIG. 4.

FIG. 6 is a flowchart illustrating an example of a process flow of the multi-function apparatus subsequent to the process flow illustrated in FIG. 5.

FIG. 7 is a flowchart illustrating an example of a process flow of the mobile terminal according to the first example embodiment.

FIG. 8 is a flowchart illustrating an example of a process flow of the mobile terminal subsequent to the process flow illustrated in FIG. 7.

FIG. 9 is a flowchart illustrating an example of a process flow of the mobile terminal subsequent to the process flow illustrated in FIG. 8.

FIG. 10 describes a display example that is displayed on an operation panel of the multi-function apparatus in accordance with a process performed in step S103 of FIG. 4.

FIG. 11 describes a display example that is displayed on the operation panel of the multi-function apparatus in accordance with a process performed in step S107 of FIG. 4.

FIG. 12 describes a display example that is displayed on an operation panel of the mobile terminal in accordance with a process performed in step S305 of FIG. 7.

FIG. 13 describes a display example that is displayed on the operation panel of the mobile terminal in accordance with a process performed in step S311 of FIG. 8.

FIG. 14 describes a display example that is displayed on the operation panel of the mobile terminal in accordance with a process performed in step S314 of FIG. 8.

FIG. 15 describes a display example that is displayed on the operation panel of the mobile terminal in accordance with a process performed in step S317 of FIG. 8.

FIG. 16 describes a display example that is displayed on the operation panel of the mobile terminal in accordance with a process performed in step S401 of FIG. 9.

FIG. 17 describes a display example that is displayed on the operation panel of the mobile terminal in accordance with a process performed in step S404 of FIG. 9.

FIG. 18 describes an example of a list of abbreviated dialing codes stored in the multi-function apparatus according to the first example embodiment.

FIG. 19 describes an example of a list of sets of content in an address book stored in the mobile terminal according to the first example embodiment.

FIG. 20 describes an example of information stored in the multi-function apparatus according to the first example embodiment.

FIG. 21 describes an example of information stored in the mobile terminal according to the first example embodiment.

### DETAILED DESCRIPTION

Some example embodiments of the technology are described in detail below in the following order with reference to the accompanying drawings. Note that the following description is directed to illustrative examples of the technology and not to be construed as limiting to the technology. Factors including, without limitation, numerical values, shapes, materials, components, positions of the components, and how the components are coupled to each other are illustrative only and not to be construed as limiting to the technology. Further, elements in the following example embodiments which are not recited in a most-generic independent claim of the technology are optional and may be provided on an as-needed basis. The drawings are schematic and are not intended to be drawn to scale. Note that the like elements are denoted with the same reference numerals, and any redundant description thereof will not be described in detail.

### 1. First Example Embodiment

### 1.1 Configuration

### 1.2 Operation

### 1.3 Effects

### 2. Other Example Embodiments

### [1. First Example Embodiment]

A first example embodiment of the technology relates to an information communication system that prevents a mistake in facsimile transmission, and performs facsimile transmission from a multi-function apparatus, after a telephone call is made to a particular individual by utilizing a mobile terminal and an application in the mobile terminal.

### [1.1 Configuration]

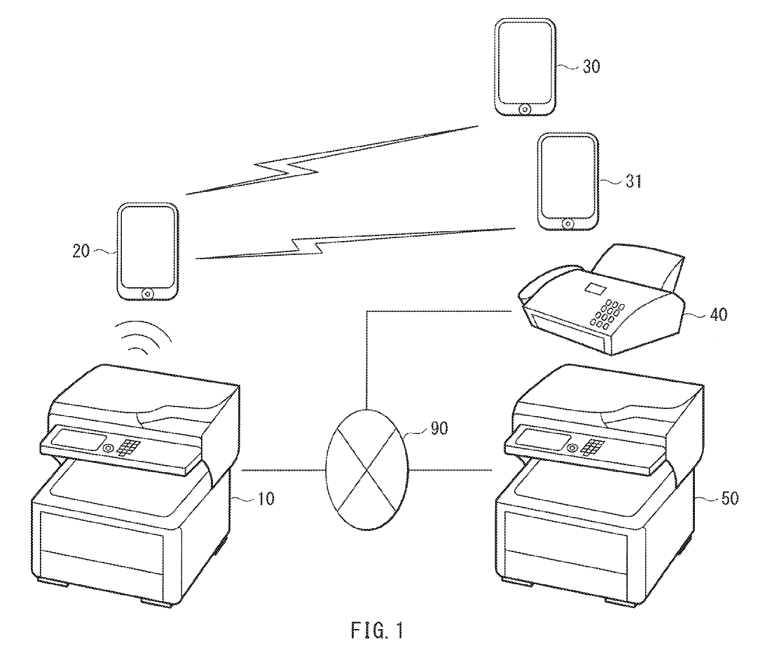

FIG. 1 illustrates a schematic configuration of the information communication system according to the first example embodiment of the technology.

The information communication system according to the first example embodiment may include a multi-function apparatus 10, a mobile terminal 20, a mobile terminal 30, a mobile terminal 31, a facsimile apparatus 40, a multi-function apparatus 50, and a communication line 90. The communication line 90 may be directed to facsimile communication. The multi-function apparatus 10 may correspond to an “image communication apparatus” in one specific but non-limiting embodiment of the technology. The mobile terminal 20 may correspond to a “mobile terminal” in one specific but non-limiting embodiment of the technology.

The multi-function apparatus 10 and the multi-function apparatus 50 may each have a configuration with multiple functions such as a facsimile apparatus function, a copying machine function, and a printer function.

The first example embodiment is described referring to an example case where the facsimile apparatus 40 is provided with a telephone, and each of the multi-function apparatus 10 and the multi-function apparatus 50 is provided with no telephone.

The mobile terminal 20, the mobile terminal 30, and the mobile terminal 31 may each be a mobile device such as a tablet terminal and a smartphone. Each of the mobile terminals 30 and 31 may be an example target to which the mobile terminal 20 makes a telephone call.

Each of the facsimile apparatus 40 and the multi-function apparatus 50 may be an example target to which a facsimile is transmitted by the multi-function apparatus 10.

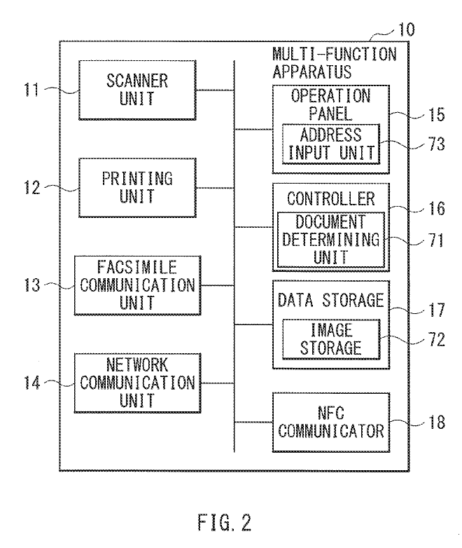

FIG. 2 illustrates an example of an internal configuration of the multi-function apparatus 10.

The multi-function apparatus 10 may include a scanner unit 11, a printing unit 12, a facsimile communication unit 13, a network communication unit 14, an operation panel 15, a controller 16, a data storage 17, and an near field communication (NFC) communicator 18.

The scanner unit 11 may read a document to be subjected to the facsimile transmission, and generate a document image. The scanner unit 11 may correspond to a “reader” in one specific but non-limiting embodiment of the technology. The facsimile communication unit 13 may transmit the document image to an apparatus such as the facsimile apparatus 40 and the multi-function apparatus 50 via the communication line 90. The facsimile communication unit 13 may correspond to a “document transmitter” in one specific but non-limiting embodiment of the technology.

It is to be noted that, as used herein, the term “scan-to-fax” refers to scanning of the document by the scanner unit 11 and performing of the facsimile transmission of the scanned document by the facsimile communication unit 13.

The network communication unit 14 may be a communication interface directed to communication with the mobile terminal 20 via network communication. The network communication may be, for example but not limited to, a local area network (LAN), the Internet, or any other suitable communication.

The NFC communicator 18 may be a communication interface directed to NFC with the mobile terminal 20.

The operation panel 15 may have a screen on which various pieces of information are to be displayed. The screen may be, for example but not limited to, a touch panel.

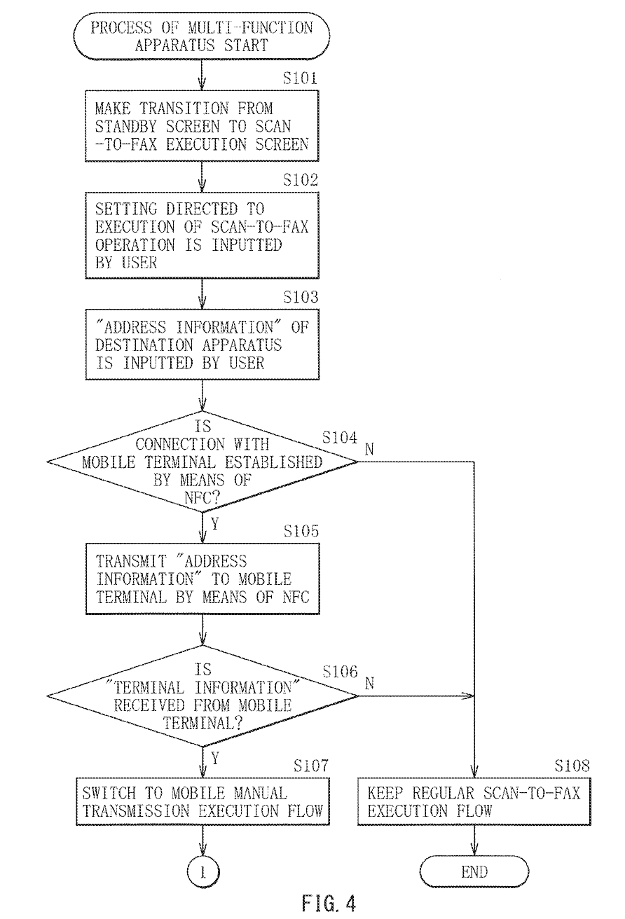

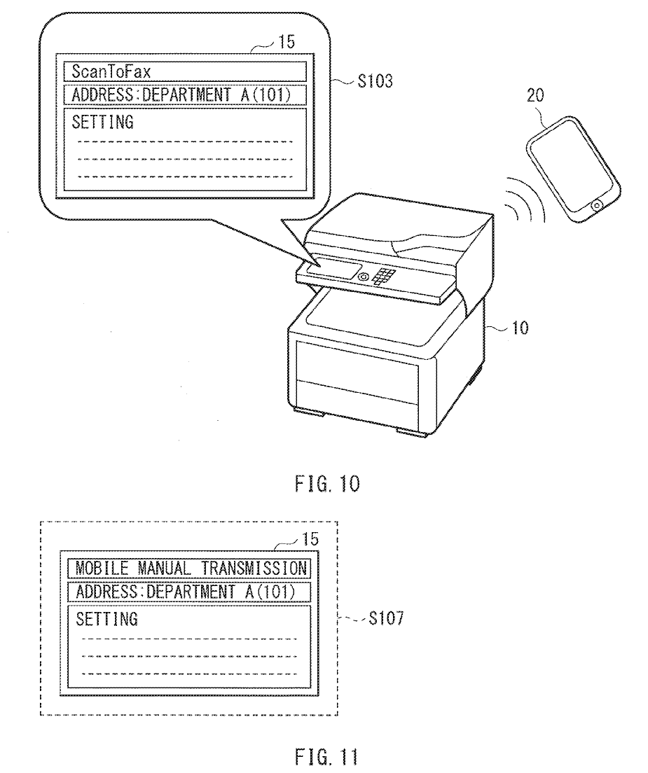

The operation panel 15 may display a standby screen in accordance with a process in step S101 of FIG. 4, a scan-to-fax execution screen illustrated in FIG. 10, a setting screen in accordance with a process in step S102 of FIG. 4, or any other screen, all of which will be described later in greater detail. The operation panel 15 may also display an input screen for “address information” in accordance with a process in step S103 of FIG. 4, a mobile manual transmission screen, i.e., a screen directed to a manual transmission mode, illustrated in FIG. 11, a screen that prompts a user to set the document and is in accordance with a process in step S117, or any other screen, all of which will be described later in greater detail.

The data storage 17 may be a storage medium that stores various pieces of information. The data storage 17 is not limited in its format of the storage medium. The data storage 17 may store information of the document image in association with the “address information”, “terminal information”, and “personal information”, as illustrated in FIG. 20, in accordance with a later-described process in step S119. The “terminal information” may be, for example to but not limited to, a media access control (MAC) address.

The controller 16 may include a central processing unit (CPU). The controller 16 may perform a control of each block in the multi-function apparatus 10. Further, the controller 16 may execute main operations in process flows illustrated in FIGS. 4 to 6 which will be described later.

The multi-function apparatus 10 may also have the following functions.

The network communication unit 14 and the NFC communicator 18 may receive transmission information from the mobile terminal 20 in accordance with processes in step S201, etc. which will be described later. The transmission information may include an instruction to transmit the document image, i.e., a facsimile transmission command, and registration information of the mobile terminal 20. The registration information may be, for example but not limited to, terminal information of the mobile terminal 20. The network communication unit 14 and the NFC communicator 18 may have a function of receiving, from the mobile terminal 20, personal information related to the address information of the document image, in accordance with processes in step S114, etc. which will be described later. The network communication unit 14 and the NFC communicator 18 may correspond to a “transmission information receiver” in one specific but non-limiting embodiment of the technology.

The controller 16 may also serve as a document determining unit 71. The document determining unit 71 may determine, in accordance with later-described processes in step S202, etc., one of a document and the document image both corresponding to the registration information, when the network communication unit 14 and the NFC communicator 18 receive the transmission information.

Moreover, the controller 16 and the facsimile communication unit 13 may transmit one of the read image of the document and the document image on the basis of the determination made by the document determining unit 71. The transmission of one of the read image of the document and the document image may be performed in accordance with processes in step S202, etc. which will be described later. The controller 16 and the facsimile communication unit 13 may correspond to the “document transmitter” in one specific but non-limiting embodiment of the technology. The document determining unit 71 may have a function of determining one of the document and the document image both corresponding to the registration information on the basis of the information stored in the image storage 72, in accordance with the processes in step S202, etc. which will be described later. The information stored in image storage 72 may be, for example but not limited to, information illustrated in FIG. 20 which will be described later.

The data storage 17 may serve as the image storage 72. The image storage 72 may store the document image generated by the scanner unit 11, at least in association with the registration information. The storing of the document image may be performed in accordance with processes in step S19, etc. which will be described later. The image storage 72 may store the document image generated by the scanner unit 11, in association with the address information, the registration information, and the personal information. The storing of the document image may be performed in accordance with the processes in step S119, etc. described later.

The operation panel 15 may serve as the address input unit 73. The address input unit 73 may accept input of the address information of the document image as illustrated in FIG. 10. The acceptance of the input of the address information of the document image may be performed in accordance with processes in step S103, etc., which will be described later.

The NFC communicator 18 may transmit the address information to the mobile terminal 20, in accordance with processes in step S105, etc. which will be described later. The transmission of the address information may be performed when the input of the address information is performed on the address input unit 73 in accordance with the processes in step S103, etc., which will be described later. The NFC communicator 18 may correspond to an “address transmitter” in one specific but non-limiting embodiment of the technology.

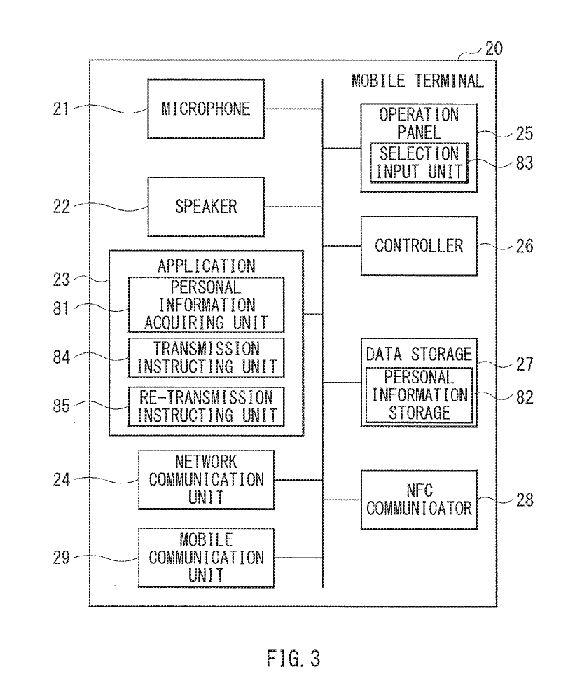

FIG. 3 illustrates an example of an internal configuration of the mobile terminal 20.

The mobile terminal 20 may include a microphone 21, a speaker 22, an application 23, a network communication unit 24, an operation panel 25, a controller 26, a data storage 27, an NFC communicator 28, and a mobile communication unit 29.

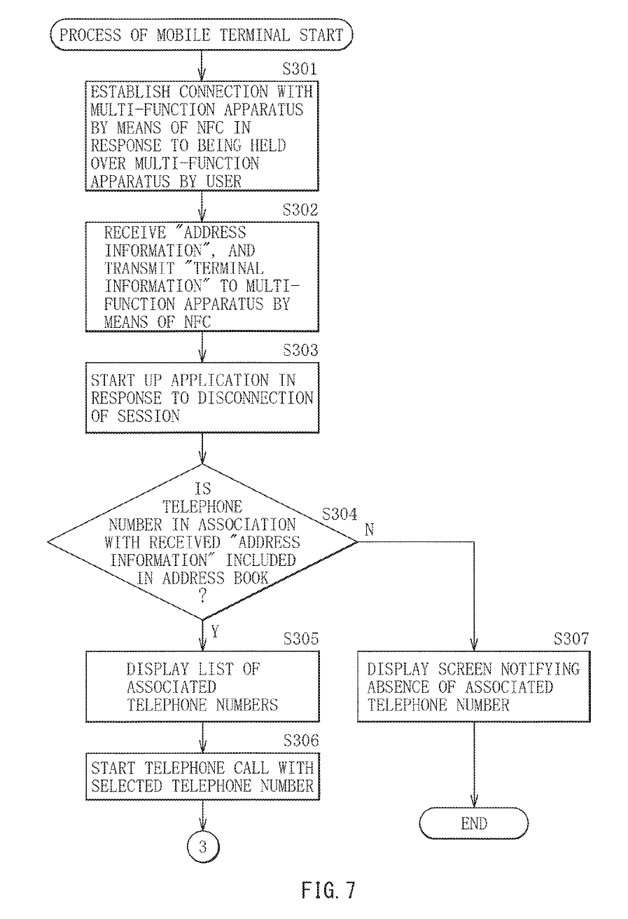

The controller 26 may include a CPU. The controller 26 may perform a control of each block in the mobile terminal 20. The application 23 may execute main operations in process flows illustrated in FIGS. 7 to 9 which will be described later.

The network communication unit 24 may be a communication interface directed to communication with the multi-function apparatus 10 via network communication such as the LAN and the Internet.

The NFC communicator 28 may be a communication interface directed to NFC with the multi-function apparatus 10.

The mobile communication unit 29 may be a communication interface directed to mobile communication with any of the mobile terminals 30 and 31 other than the mobile terminal 20. The mobile communication unit 29 may have a function of making a telephone call, i.e., a function of performing telephone communication. The mobile communication unit 29 may be therefore able to make a telephone call to any of the other mobile terminals 30 and 31 and the facsimile apparatus 40.

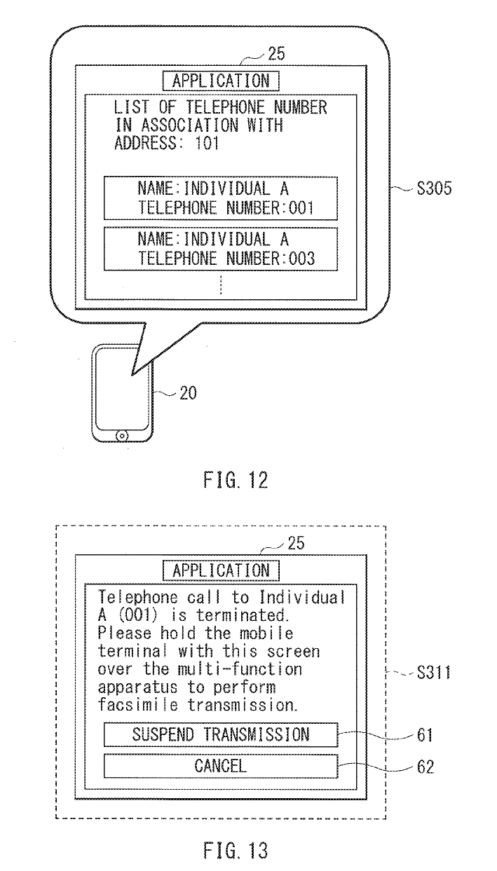

The operation panel 25 may have a screen on which various pieces of information are to be displayed. The screen may be, for example but not limited to, a touch panel. The operation panel 25 may display a list of telephone numbers such as that illustrated in FIG. 12 which will be described later, a post-call screen such as that illustrated in FIG. 13 which will be described later, or any other suitable screen. The post-call screen may refer to a screen that is displayed after the telephone call is terminated. The post-call screen may include a “suspend transmission” button 61 and a “cancel” button 62.

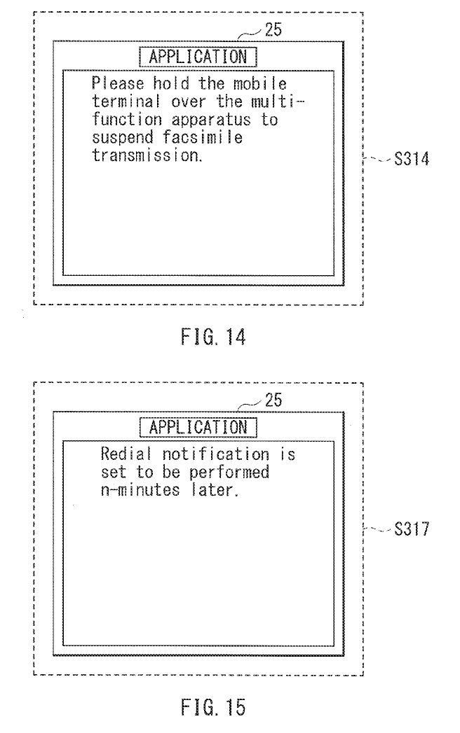

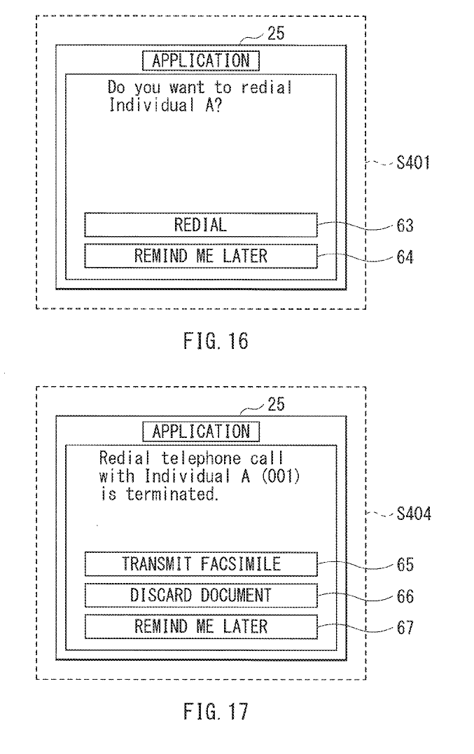

The operation panel 25 may also display a transmission suspension screen such as that illustrated in FIG. 14, a redial notification setting screen such as that illustrated in FIG. 15, a redial notification screen such as that illustrated in FIG. 16, a redial termination screen such as that illustrated in FIG. 17, and any other suitable screen, all of which will be described later in greater detail. The redial notification screen may include a “redial” button 63 and a “remind me later” button 64. The redial termination screen may include a “transmit facsimile” button 65, a “discard document” button 66, and a “remind me later” button 67.

The data storage 27 may be a storage medium that stores various pieces of information. The data storage 27 is not limited in its format of the storage medium.

The mobile terminal 20 may also have the following functions.

The data storage 27 may serve as a personal information storage 82. The personal information storage 82 may store the address information and the personal information related to the address information in association with each other as illustrated in FIG. 19 which will be described later. The address information may include, for example but not limited to, a facsimile number. The personal information may include, for example but not limited to, a telephone number.

The NFC communicator 28 may receive the address information from the multi-function apparatus 10 in accordance with processes in step S302, etc. which will be described later. The NFC communicator 28 may correspond to an “address information receiver” in one specific but non-limiting embodiment of the technology.

The application 23 may serve as a personal information acquiring unit 81. The personal information acquiring unit 81 may acquire, from the personal information storage 82, the personal information corresponding to the address information received by the NFC communicator 28. The acquiring of the personal information may be performed in accordance with processes in step S302, etc. which will be described later.

The mobile communication unit 29 may have a function of performing mobile communication based on the personal information acquired by the personal information acquiring unit 81. The mobile communication based on the personal information may be performed in accordance with processes in step S306, etc. which will be described later.

Further, the mobile communication unit 29 may have a function of performing the telephone communication based on the telephone number included in the personal information.

The application 23 may serve as a transmission instructing unit 84. The transmission instructing unit 84 may transmit, to the multi-function apparatus 10, the instruction to transmit the document image, after the mobile communication is performed. The transmission of the instruction to transmit the document image may be performed in accordance with processes in step S313, etc., which will be described later. The transmission instructing unit 84 may have a function of transmitting, to the multi-function apparatus 10, the instruction to transmit the document image, after re-communication, i.e., redial, is executed. The transmission of the instruction to transmit the document image may be performed in accordance with processes in steps S404 to S406, etc. which will be described later.

The operation panel 25 may serve as a selection input unit 83. The selection input unit 83 may prompt the user to select whether to perform the re-communication, i.e., the redial, as illustrated in FIG. 16, after the mobile communication is performed by the mobile communication unit 29. The prompting of the user to select whether to perform the re-communication, i.e., the redial, may be performed in accordance with processes in step S401, etc. which will be described later.

Further, the operation panel 25 may serve as a re-communication termination screen display unit. The re-communication termination screen display unit may display, for example, the redial notification screen illustrated in FIG. 17 and serving as a recommunication termination screen, after the redial is executed, as in a process in step S404 described later. The redial notification screen may include a display directed to giving an instruction to discard the document image, i.e., the “discard document” button 66, and a display directed to giving the instruction to transmit the document image, i.e., the “transmit facsimile” button 65.

Further, the operation panel 25 may serve as a post-call screen display unit. The post-call screen display unit may display, for example, the post-call screen illustrated in FIG. 13, after the telephone call of the telephone communication performed by the mobile communication unit 29 is terminated, as in a process in step S311 described later.

Further, the operation panel 25 may serve as a transmission suspension screen display unit. The transmission suspension screen display unit may display, for example, the transmission suspension screen illustrated in FIG. 14, as in a process in step S314 described later, when an instruction is given to suspend the instruction to transmit the document image, for example, by operating the “suspend transmission” button 61 on the post-call screen illustrated in FIG. 13.

The application 23 may serve as a re-communication instructing unit 85. The re-communication instructing unit 85 may cause the mobile communication unit 29 to execute the re-communication, when the selection is made to perform the re-communication. The causing the mobile communication unit 29 to execute the re-communication may be performed in accordance with processes in steps S402, S403, etc. which will be described later.

### [1.2 Operation]

### [Operation of Multi-function Apparatus 10]

FIGS. 4, 5, and 6 each illustrate an example of a process flow of the multi-function apparatus 10 according to the first example embodiment.

A description is given first of the process flow illustrated in FIG. 4. The process flow of the multi-function apparatus 10 according to the first example embodiment may start from a point at which the user intends to transmit a facsimile to an intended person. In order to allow the user to perform the facsimile transmission, the screen displayed on the operation panel 15 of the multi-function apparatus 10 may make a transition from the standby screen to the scan-to-fax execution screen (step S101). Thereafter, setting directed to the execution of the scan-to-fax operation may be inputted by the user (step S102). The setting directed to the execution of the scan-to-fax operation may include a resolution, a communication speed, and any other suitable factor, for example. Thereafter, the “address information” such as a facsimile number of a destination apparatus may be inputted by the user (step S103). The destination apparatus may be an apparatus to which the facsimile is intended to be transmitted. Thereafter, the multi-function apparatus 10 may start the NFC by the NFC communicator 18, and determine whether connection is established with the mobile terminal 20 (step S104).

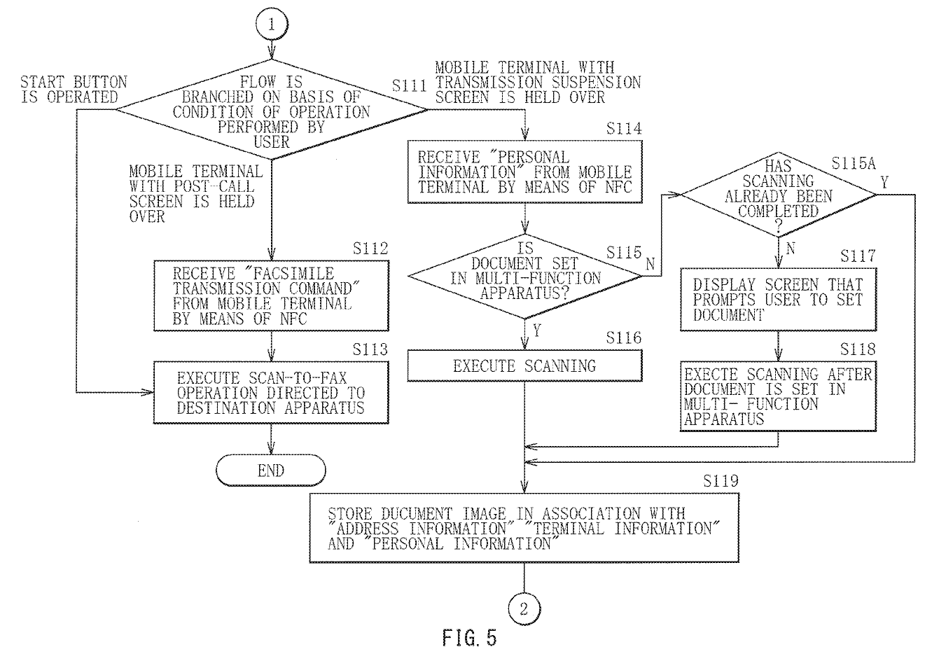

When the user holds the mobile terminal 20 over the NFC communicator 18 of the multi-function apparatus 10 as illustrated in FIG. 10, and the connection between the multi-function apparatus 10 and the mobile terminal 20 is established by means of the NFC (step S104: Y), the “address information” of the destination apparatus inputted in step S103 may be transmitted from the multi-function apparatus 10 to the mobile terminal 20 (step S105). On this occasion, the mobile terminal 20 that has received the “address information” may transmit the “terminal information” to the multi-function apparatus 10 by means of the NFC. The “terminal information” may be directed to identification of the mobile terminal 20, and may be, for example but not limited to, the MAC address. When the multi-function apparatus 10 receives the “terminal information” from the mobile terminal 20 without any error (step S106: Y), the flow may be switched to a mobile manual transmission execution flow, and the screen displayed on the operation panel 15 may be switched to a mobile manual transmission screen, i.e., the screen directed to the manual transmission mode, as illustrated in FIG. 11, (step S107). Thereafter, the process may make a transition to the subsequent flow illustrated in FIG. 5. On this occasion, when the document has been already set in the multi-function apparatus 10, the document may be subjected to scanning subsequently. In this case, the scanning may be performed in advance while the user is in the middle of the telephone call with the intended person. When the connection between the multi-function apparatus 10 and the mobile terminal 20 is not able to be established by means of the NFC (step S104: N), or when the multi-function apparatus 10 is prevented from receiving the “terminal information” from the mobile terminal 20 for some reason (step S106: N), the process of the multi-function apparatus 10 may end while the regular scan-to-fax execution flow is kept without making a transition to another flow (step S108).

FIG. 5 illustrates a process flow of the multi-function apparatus 10 after the user terminates the telephone call with the intended person by means of the mobile terminal 20. The following description is given on the basis of an example assumed case where no scanning is performed in advance.

The multi-function apparatus 10 may monitor an operation performed by the user, and the flow may be branched on the basis of the condition of operation performed by the user (step S111). After the user terminates the telephone call with the intended person, the user may be allowed to select whether to execute the facsimile transmission to the destination apparatus subsequently. When the facsimile transmission to the destination apparatus is to be executed subsequently, the scan-to-fax operation may be executed by the following two methods. A first method may be to operate a “start” button of the multi-function apparatus 10. A second method may be to hold the mobile terminal 20 over the multi-function apparatus 10. On this occasion, the post-call screen may be displayed on the mobile terminal 20. In the second method, the multi-function apparatus 10 may receive a “facsimile transmission command” from the mobile terminal 20 by means of the NFC (step S112). The scan-to-fax operation may be executed in response to the reception of the “facsimile transmission command” as a trigger (step S113).

In contrast, when the facsimile transmission to the destination apparatus is not to be executed subsequently, it may be possible for the user to suspend the facsimile transmission with the current setting and allow the facsimile transmission with the current setting to be accumulated in the multi-function apparatus 10. The suspension and accumulation of the facsimile transmission with the current setting may be performed by holding the mobile terminal 20 with the transmission suspension screen over the multi-function apparatus 10. On this occasion, the multi-function apparatus 10 may receive the “personal information” from the mobile terminal 20 by means of the NFC (step S114). The personal information” may be directed to identification of an individual. The “personal information” may be, for example but not limited to, a name of the individual corresponding to the “address information”. The “personal information” may be any information as long as the intended person is able to be identified uniquely by the information. Thereafter, the multi-function apparatus 10 may determine whether the document is set (step S115). When a determination is made that the document is set (step S115: Y), the multi-function apparatus 10 may execute scanning of the document in response to the reception of the “personal information” in step S114 as a trigger (step S116). When a determination is made that no document is set (step S115: N), the multi-function apparatus 10 may then determine whether the scanning of the document has been already completed (step S115A). When a determination is made that the scanning of the document has not been completed yet (step S115A: N), the multi-function apparatus 10 may display a screen that prompts the user to set the document (step S117). When the document is set, the multi-function apparatus 10 may execute the scanning of the document (step S118). Thereafter, the multi-function apparatus 10 may store one of the document image determined to be already scanned in step S115A, the document image scanned in step S116, and the document image scanned in step S118, in association with the “address information”, the “terminal information”, and the “personal information” (step S119). It is to be noted that the information stored in the multi-function apparatus 10 may be automatically discarded after elapse of a certain period of time. For example, the information stored in the multi-function apparatus 10 may be automatically discarded after the elapse of two hours.

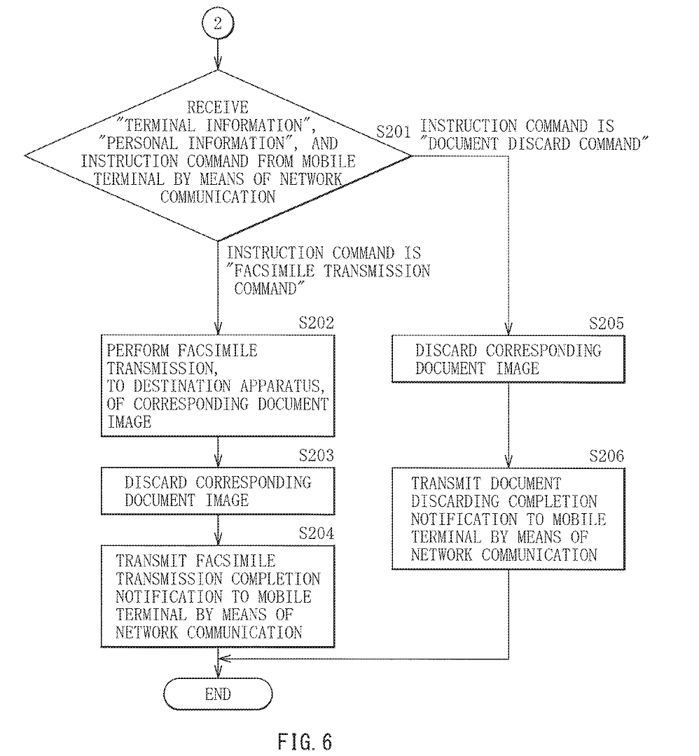

FIG. 6 illustrates a process flow of the multi-function apparatus 10 after the facsimile transmission to the destination apparatus is tentatively suspended in the process flow illustrated in FIG. 5.

The process flow illustrated in FIG. 6 may be based on an example assumed case where the user has been already away from the multi-function apparatus 10. The user away from the multi-function apparatus 10 may be able to transmit the “terminal information”, the “personal information”, and the instruction command from the mobile terminal 20 to the multi-function apparatus 10 by means of the network communication. The multi-function apparatus 10 may receive the “terminal information”, the “personal information”, and the instruction command from the mobile terminal 20 by means of the network communication (step S201). When the received instruction command is the “facsimile transmission command”, the multi-function apparatus 10 may collate the received “terminal information” and the received “personal information” with the information stored in step S119 of FIG. 5. Further, the multi-function apparatus 10 may perform the facsimile transmission of the corresponding document image to the destination apparatus (step S202). The corresponding document image may be the document image in association with the “terminal information” and the “personal information” that match the “terminal information” and the “personal information” received from the mobile terminal 20. After the facsimile transmission is completed, the multi-function apparatus 10 may discard the document image subjected to the facsimile transmission and the pieces of information in association with the document image (step S203). Thereafter, the multi-function apparatus 10 may transmit a facsimile transmission completion notification to the mobile terminal 20 by means of the network communication (step S204). The facsimile transmission completion notification may notify the completion of the facsimile transmission. When the received instruction command is a “document discard command”, the multi-function apparatus 10 may collate the received “terminal information” and the received “personal information” with the information stored in step S119 of FIG. 5, and discard the corresponding document image (step S205). The corresponding document image may be the document image in association with the “terminal information” and the “personal information” that match the “terminal information” and the “personal information” received from the mobile terminal 20. Thereafter, the multi-function apparatus 10 may transmit a document discarding completion notification to the mobile terminal 20 by means of the network communication (step S206). The document discarding completion notification may notify the completion of the discarding of the document image.

### [Operation of Mobile Terminal 20]

FIGS. 7, 8, and 9 each illustrate an example of a process flow of the mobile terminal 20 according to the first example embodiment.

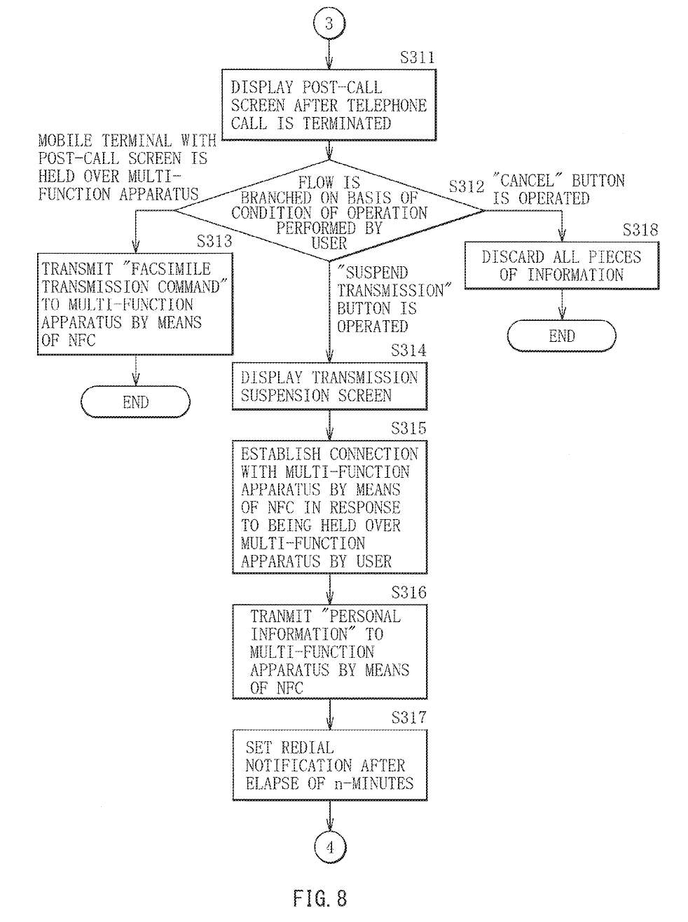

A description is given first of the process flow illustrated in FIG. 7. The process flow of the mobile terminal 20 according to the first example embodiment may start from a point at which the user holds the mobile terminal 20 over the NFC communicator 18 of the multi-function apparatus 10 as illustrated in FIG. 10 in step S104 of FIG. 4. When the mobile terminal 20 is held over the multi-function apparatus 10 by the user, the connection between the mobile terminal 20 and the multi-function apparatus 10 may be established by means of the NFC (step S301). In response to the establishment of the connection between the mobile terminal 20 and the multi-function apparatus 10, the “address information” of the destination apparatus may be transmitted from the multi-function apparatus 10. The “address information” of the destination apparatus may be, for example but not limited to, the facsimile number of the destination apparatus. The mobile terminal 20 may receive the “address information” such as the facsimile number of the destination apparatus, and may transmit the “terminal information” to the multi-function apparatus 10 by means of the NFC (step S302). The “terminal information” may be directed to identification of the mobile terminal 20. The mobile terminal 20 may start up the application 23 in response to disconnection of a session by means of the NFC as a trigger (step S303). Thereafter, the mobile terminal 20 may perform a searching process with the use of the application 23 (step S304). The searching process may determine whether a telephone number in association with the “address information” received from the multi-function apparatus 10 in step S201 is included in the address book of the mobile terminal 20. A process to be performed by the mobile terminal 20 thereafter may be on the basis of an example assumed case where the process is basically executed with the use of the application 23. A specific but non-limiting method of the searching process will be described later in greater detail. When the associated telephone number, i.e., the telephone number in association with the “address information” received from the multi-function apparatus 10, is included in the address book of the mobile terminal 20 as a result of the searching process (step S304: Y), a list of the associated telephone numbers may be displayed on the operation panel 25 as illustrated in FIG. 12 (step S305). The user may start a telephone call with the intended person by selecting one of the telephone numbers in the list of the associated telephone numbers (step S306). Thereafter, the process may make a transition to the flow illustrated in FIG. 8. When the associated telephone number is not included in the address book of the mobile terminal 20 (step S304: N), a screen that notifies the absence of the associated telephone number may be displayed on the operation panel 25 (step S307), and the process of the mobile terminal 20 may end.

FIG. 8 illustrates the process flow of the mobile terminal 20 after the user terminates the telephone call with the intended person.

After the user terminates the telephone call with the intended person, the mobile terminal 20 may display the post-call screen such as that illustrated in FIG. 13 (step S311). Thereafter, the mobile terminal 20 may monitor the operation performed by the user, and the flow may be branched on the basis of the condition of operation performed by the user (step S312). The post-call screen may display a display indicating that the instruction to transmit the document image is allowed to be given by holding the mobile terminal 20 over the multi-function apparatus 10. Further, the post-call screen may display a display directed to giving an instruction to suspend the instruction to transmit the document image, i.e., the “suspend transmission” button 61. On this occasion, when the mobile terminal 20 that keeps displaying the post-call screen is held over the multi-function apparatus 10 by the user, the “facsimile transmission command” may be transmitted from the mobile terminal 20 to the multi-function apparatus 10 by means of the NFC (step S313). The multi-function apparatus 10 that has received the “facsimile transmission command” may execute the scan-to-fax operation.

When the intended person is absent or when it is inconvenient for the intended person to receive the facsimile transmission immediately, it is possible for the user to suspend, with the use of the mobile terminal 20, the facsimile transmission that is to be performed by the multi-function apparatus 10. In this case, in response to an operation by the user of the “suspend transmission” button 61 displayed on the post-call screen of the mobile terminal 20, the mobile terminal 20 may display a transmission suspension screen such as that illustrated in FIG. 14 (step S314). When the mobile terminal 20 that keeps displaying the transmission suspension screen is held over the multi-function apparatus 10 by the user (step S315), the mobile terminal 20 may transmit the “personal information” to the multi-function apparatus 10 by means of the NFC (step S316). This may cause the multi-function apparatus 10 to accept the suspension of the facsimile transmission with the current setting. This may also set the mobile terminal 20 to make a redial notification after the elapse of n-minutes as illustrated in FIG. 15 (step S317). The timing to make the redial notification may be set in advance.

In a case where the user performs neither of the facsimile transmission nor the suspension of the facsimile transmission, the user may operate the “cancel” button 62 on the post-call screen illustrated in FIG. 13. In this case, in response to the operation, by the user, of the “cancel” button 62 displayed on the post-call screen of the mobile terminal 20, the mobile terminal 20 may discard all the pieces of information (step S318), and end the process.

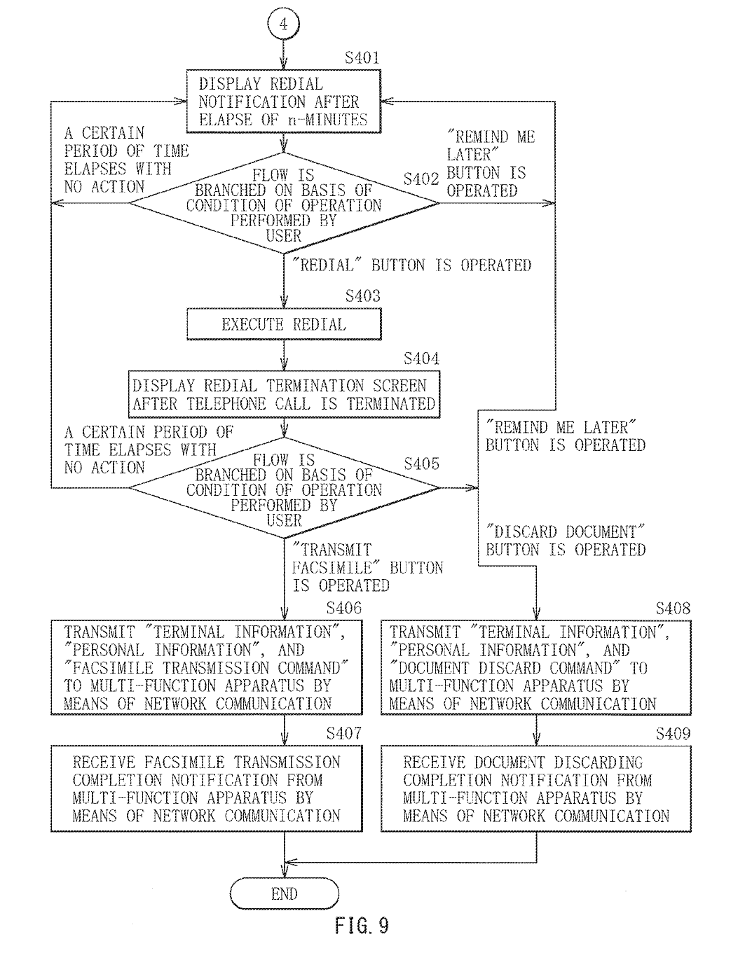

FIG. 9 illustrates the process flow of the mobile terminal 20 that is to be performed after the redial notification is set in step S317 of FIG. 8.

The process flow illustrated in FIG. 9 is based on an example assumed case where the user has been already away from the multi-function apparatus 10. After the elapse of n-minutes, the mobile terminal 20 may display a redial notification screen as illustrated in FIG. 16 (step S401). Thereafter, the mobile terminal 20 may monitor the operation performed by the user, and the flow may be branched on the basis of the condition of operation performed by the user (step S402). The redial notification screen may allow the user to select whether to execute the redial.

When the “redial” button 63 is operated by the user on the redial notification screen, the mobile terminal 20 may execute the redial directed to the intended person (step S403). After a telephone call made by the redial is terminated, the mobile terminal 20 may display a redial termination screen such as that illustrated in FIG. 17 (step S404). Thereafter, the mobile terminal 20 may monitor the operation performed by the user, and the flow may be branched on the basis of the condition of operation performed by the user (step S405).

When the “transmit facsimile” button 65 is operated by the user on the redial termination screen, the mobile terminal 20 may transmit the “terminal information”, the “personal information”, and the “facsimile transmission command” to the multi-function apparatus 10 by means of the network communication (step S406). When the multi-function apparatus 10 receives the “terminal information”, the “personal information”, and the “facsimile transmission command”, the multi-function apparatus 10 may collate the received “terminal information” and the received “personal information” with the information stored in the multi-function apparatus 10. Further, the multi-function apparatus 10 may perform the facsimile transmission of the associated document image, i.e., the document image in association with the “terminal information” and the “personal information” received from the mobile terminal 20, to the destination apparatus. After completion of the facsimile transmission of the associated document image, the multi-function apparatus 10 may discard the associated document image and the pieces of information in association with the document image. The multi-function apparatus 10 may also transmit a facsimile transmission completion notification to the mobile terminal 20 by means of the network transmission. The facsimile transmission completion notification may notify the completion of the facsimile transmission. The mobile terminal 20 may receive the facsimile transmission completion notification (step S407), and end the process.

When the “discard document” button 66 is operated by the user on the redial termination screen, the mobile terminal 20 may transmit the “terminal information”, the “personal information”, and the “document discard command” to the multi-function apparatus 10 by means of the network communication (step S408). When the multi-function apparatus 10 receives the “terminal information”, the “personal information”, and the “document discard command”, the multi-function apparatus 10 may collate the received “terminal information” and the received “personal information” with the information stored in the multi-function apparatus 10. Further, the multi-function apparatus 10 may discard the associated document image, i.e., the document image in association with the received “terminal information” and the received “personal information”. Thereafter, the multi-function apparatus 10 may transmit a document discarding completion notification to the mobile terminal 20 by means of the network communication. The mobile terminal 20 may receive the document discarding completion notification (step S409), and end the process.

The redial notification may be displayed on the mobile terminal 20 again after the elapse of n-minutes, in the following three cases. A first case may be a case where the “remind me later” button 64 is operated on the redial notification screen illustrated in FIG. 16 in step S409. A second case may be a case where the “remind me later” button 67 is operated on the redial termination screen illustrated in FIG. 17 in step S405. A third case may be a case where a certain period of time elapses while the user takes no action on the redial notification screen illustrated in FIG. 16 in step S409 or on the redial termination screen illustrated in FIG, 17 in step S405. This may be also applicable to a case where the user unintentionally terminates the application 23 on the redial notification screen illustrated in FIG. 16 or on the redial termination screen illustrated in FIG. 17.

### [Examples of Information Stored in Multi-function Apparatus 10 and Mobile Terminal 20]

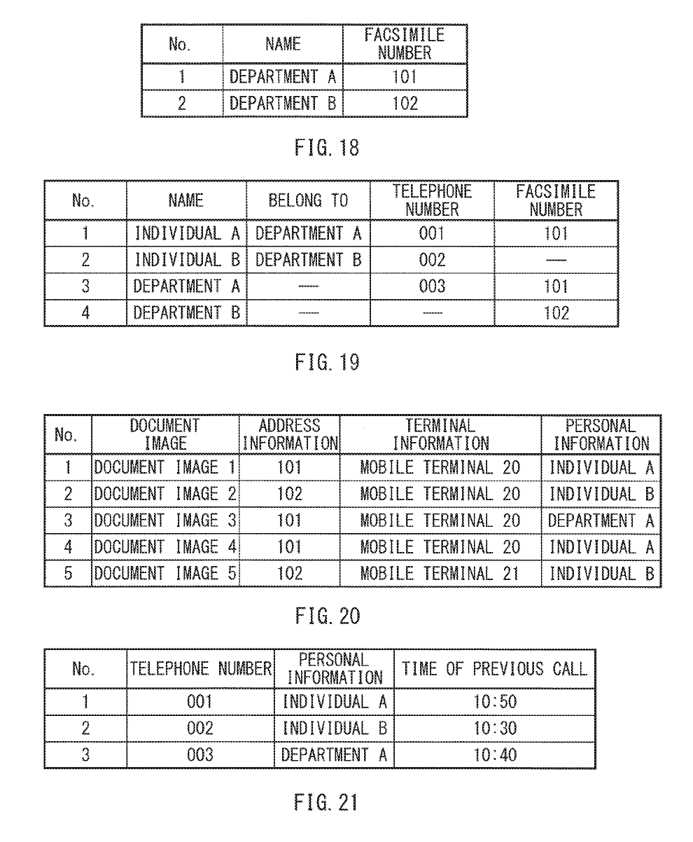

FIG. 18 illustrates an example of a list of abbreviated dialing codes stored in the multi-function apparatus 10. FIG. 19 illustrates an example of a list of sets of content in the address book stored in the mobile terminal 20.

A description is given below of a specific but non-limiting method of performing the searching process. The searching process may determine whether the telephone number in association with the “address information” of the destination apparatus received by the mobile terminal 20 from the multi-function apparatus 10 in step S302 of FIG. 7 is included in the address book of the mobile terminal 20.

The description below refers to an example case where two abbreviated dialing codes are registered in the multi-function apparatus 10 as illustrated in FIG. 18 and four sets of content are registered in the mobile terminal 20 as illustrated in FIG. 19. In this example, the telephone number of the mobile terminal 30 is “001”, the telephone number of the mobile terminal 31 is “002”, the telephone number of the facsimile apparatus 40 is “003”, the facsimile number of the facsimile apparatus 40 is “101”, and the facsimile number of the multi-function apparatus 50 is “102”.

A description is given below of two specific but non-limiting example cases. The first case is a case where the “address information” of the destination apparatus inputted to the multi-function apparatus 10 by the user in step S103 of FIG. 4 is “101”. In this case, a determination is made in step S304 of FIG. 7 that the telephone number in association with the “address information” is included in the address book of the mobile terminal 20. Therefore, the telephone number “001” of an individual A of a set of content No. 1 and the telephone number “003” of a department A of a set of content No. 3 are displayed on the mobile terminal 20 in step S305. In a case where the user wants for the particular individual A to receive the content of the facsimile, the user makes a telephone call to the mobile terminal 30 having the telephone number “001”. In an alternative case where a person who receives the content of the facsimile can be anyone in the department A, the user makes a telephone call to the facsimile apparatus 40 having the telephone number “003”.

The second case is a case where the “address information” of the destination apparatus inputted to the multi-function apparatus 10 by the user in step S103 of FIG. 4 is “102”. In this case, a determination is made in step S304 of FIG. 7 that the telephone number in association with the “address information” is included in the address book of the mobile terminal 20. Therefore, the telephone number “002” of an individual B of a set of content No. 2 is displayed on the mobile terminal 20 in step S305. Actually, only the department B of a set of content No. 4 is in association with the “address information” “102”. However, the individual B of the set of content No. 2 belongs to the department B. Therefore, the telephone number “002” of the individual B is displayed in association with the “address information” “102”. Accordingly, although the multi-function apparatus 50 is provided with no telephone, it is possible for the user to make a telephone call to the particular individual B before performing the facsimile transmission. This makes it possible to execute the facsimile transmission while preventing a mistake in transmission.

FIG. 20 illustrates an example of information stored in the multi-function apparatus 10 in step S119 of FIG. 5. FIG. 21 illustrates an example of information that is stored when the redial notification of the mobile terminal 20 is set in step S317 of FIG. 8.

A description is given below of a specific but non-limiting method in a case where the multi-function apparatus 10 receives the “terminal information”, the “personal information”, and the instruction command in step S201 of FIG. 6 and performs the process. The description below is given on the basis of an example assumed case where the multi-function apparatus 10 stores five document images and information in association with the respective five document images as illustrated in FIG. 20. The information in association with each of the five document images includes the “address information”, the “terminal information”, and the “personal information”. In this example, the mobile terminal 20 stores three sets of content each including a telephone number and information in association with the telephone number as illustrated in FIG. 21. The information in association with each of the three telephone numbers includes the “personal information” and a “time of previous call”. The list illustrated in FIG. 20 includes the mobile terminal 20 and another unillustrated mobile terminal 21 as examples of the “terminal information”.

A description is given below of two specific but non-limiting example cases. A first case is a case where a person to whom the redial is performed by the user with the use of the mobile terminal 20 in step 403 of FIG. 9 is the individual A. In this case, when the user intends to execute the facsimile transmission directed to the individual A, the information transmitted from the mobile terminal 20 to the multi-function apparatus 10 in step S406 of FIG. 9 includes the three pieces of information, that are, “mobile terminal 20”, “individual A”, and “facsimile transmission command”. The multi-function apparatus 10 receives the three pieces of information in step S201 of FIG. 6. Thereafter, the multi-function apparatus 10 collates the received pieces of information with the information stored in step S119 of FIG. 5. Further, the multi-function apparatus 10 performs the facsimile transmission, to the destination “101”, of the document image corresponding to the received pieces of information, i.e., the document image No. 2 in FIG. 20.

As described above, the multi-function apparatus 10 may execute the process indicated by the instruction command, only when the data storage 17 includes information having the “terminal information” and the “personal information” which respectively match the “terminal information” and the “personal information” received by the multi-function apparatus 10. When the data storage 17 includes no information having the “terminal information” and the “personal information” which respectively match the “terminal information” and the “personal information” received by the multi-function apparatus 10, the multi-function apparatus 10 may transmit, to the mobile terminal 20, information indicating an error.

### [1.3 Effects]

As described above, according to the first example embodiment, the transmission information is received from the mobile terminal, i.e., the mobile terminal 20. The transmission information includes the transmission instruction of the document image, i.e., the facsimile transmission command of the document image, and the terminal information of the mobile terminal. Further, one of the document and the document image both corresponding to the terminal information is determined. Further, the document image is transmitted on the basis of the determination. Hence, it is possible to ensure that a desired document image is transmitted with certainty.

In particular, at least the following three effects are achievable according to the first example embodiment.

Firstly, it is possible to make a telephone call while designating a particular individual, independently of whether the destination apparatus to which the facsimile transmission is to be performed is connected to a telephone. Hence, it is possible to perform the facsimile transmission to the intended person with certainty while preventing a mistake in facsimile transmission.

Secondly, the address book in the mobile terminal 20 is utilized in searching of the telephone number in association with the address information, of the destination apparatus, inputted to the multi-function apparatus 10. Therefore, the result of the searching has dependency on what is registered in the mobile terminal 20 belonging to each individual. This eliminates the necessity of inputting, to the multi-function apparatus 10, the telephone number that is personal information. This also eliminates the necessity of storing the telephone number that is personal information in the multi-function apparatus 10 in advance.

Thirdly, the application in the mobile terminal 20 has both a redial notification function and a transmission function of the facsimile document image accumulated in the multi-function apparatus 10. In a case where the intended person is absent when the user intends to perform the facsimile transmission from the multi-function apparatus 10 to the destination apparatus, a case where it is inconvenient for the intended person to receive the facsimile transmission immediately, or in any other case, this makes it possible to perform the facsimile transmission at a later time, after confirming when is convenient for the intended person.

### [2. Other Example Embodiments]

The technology is not limited to the example embodiments described above, and is modifiable in various ways.

The first example embodiment has been described above referring to an example case where the NFC is performed between the multi-function apparatus 10 and the mobile terminal 20; however, this is non-limiting. The communication between the multi-function apparatus 10 and the mobile terminal 20 may be performed by means of any other communication method such as wireless LAN communication. In this case, employment of some kind of communication method may eliminate necessity of the operation of holding the mobile terminal 20 over the multi-function apparatus 10.

The application 23 in the mobile terminal 20 according to the first example embodiment may be provided with a function of transmitting the instruction command directed to the facsimile transmission, the discarding of the document, or any other suitable operation. This makes it possible for the user to transmit the instruction command directed to the facsimile transmission, the discarding of the document, or any other suitable operation to the multi-function apparatus 10 from the application in the mobile terminal 20 at any timing other than the timing after terminating the telephone call made by redialing.

When the user operates the “transmit facsimile” button 65 or the “discard document” button 66 on the redial termination screen illustrated in FIG. 17 according to the first example embodiment, a list of the document images accumulated in the multi-function apparatus 10 may be transmitted to the mobile terminal 20 by means of the network communication. Thereby, the list of the document images may be displayed on the application in the mobile terminal 20. In this case, it is possible for the user to select, with the use of the mobile terminal 20, the document image to transmit to the intended person. For example, a plurality of document images may be accumulated in the multi-function apparatus 10 as jobs. The accumulated document images may be those which one user has intended to transmit to an intended person by means of mobile manual transmission. However, transmission of some of the accumulated document images may be found unnecessary at a later time. In this case, according to the first example embodiment, selection may be made only between transmitting all of the accumulated document images and discarding all of the accumulated document images.

Moreover, data of the document image scanned by the multi-function apparatus 10 may be stored in another apparatus that is different from the multi-function apparatus 10. In one specific but non-limiting example, the data of the scanned document image may be stored in a server that is connected to the multi-function apparatus 10 by means of network connection.

Moreover, in the example described referring to FIG. 20, the multi-function apparatus 10 may execute the process indicated by the instruction command only when the data storage 17 includes the information having the “terminal information” and the “personal information” both of which match the “terminal information” and the “personal information” received by the multi-function apparatus 10. However, the multi-function apparatus 10 may execute the process also when the data storage 17 includes the information at least having the “terminal information” which matches the “terminal information” received by the multi-function apparatus 10.

The first example embodiment has been described referring to an example case where the “terminal information” such as the MAC address is used. However, “user information” of the mobile terminal 20 registered in the mobile terminal 20 may be used instead of the “terminal information”. The “user information” of the mobile terminal 20 may be, for example but not limited to, a name of the user of the mobile terminal 20.

Moreover, when the multi-function apparatus 10 scans the document and stores the document image in the image storage 72, the multi-function apparatus 10 may generate an original management number, and associate the generated original management number with the document image. In this case, the multi-function apparatus 10 may notify the management number to the mobile terminal 20. The mobile terminal 20 may transmit the management number to the multi-function apparatus 10 when the mobile terminal 20 gives an instruction to transmit the document image. The multi-function apparatus 10 may perform the facsimile transmission of the document image in association with the management number, when the multi-function apparatus 10 receives the transmission information from the mobile terminal 20. The transmission information may include the management number and the instruction to transmit the document image.

It is possible to achieve at least the following configurations from the above-described example embodiments of the technology.

(1)

An image communication apparatus including:

a transmission information receiver that receives transmission information from a mobile terminal, the transmission information including registration information of the mobile terminal and an instruction to transmit a document image;

a document controller that determines one of a document and the document image both corresponding to the registration information, when the transmission information receiver receives the transmission information; and

a document transmitter that transmits one of the document image and a read image of the document, on the basis of the determination made by the document controller.

(2)

The image communication apparatus according to (1), further including:

a reader that reads the document and generates the document image; and

an image storage that stores, at least in association with the registration information, the document image generated by the reader.

(3)

The image communication apparatus according to (2), in which the document controller determines the document image corresponding to the registration information, on the basis of information stored in the image storage.

(4)

The image communication apparatus according to (2) or (3), in which

the transmission information receiver further receives, from the mobile terminal, personal information related to address information of the document image, and

the image storage stores the document image generated by the reader, in association with the address information, the registration information, and the personal information.

(5)

A communication system including:

a mobile terminal; and

an image communication apparatus including
a transmission information receiver that receives transmission information from the mobile terminal, the transmission information including registration information of the mobile terminal and an instruction to transmit a document image,
a document controller that determines one of a document and the document image both corresponding to the registration information, when the transmission information receiver receives the transmission information, and
a document transmitter that transmits one of the document image and a read image of the document, on the basis of the determination made by the document controller.
   (6)

The communication system according to (5),

in which the image communication apparatus further includes:
an address input interface that accepts input of address information of the document image; and
an address transmitter that transmits the address information to the mobile terminal, when the address input interface accepts the input of the address information, and

in which the mobile terminal further includes:
a personal information storage that stores the address information and personal information related to the address information in association with each other;
an address information receiver that receives the address information from the image communication apparatus;
a personal information acquiring processor that acquires, from the personal information storage, the personal information corresponding to the address information received by the address information receiver; and
a mobile communicator that performs mobile communication based on the personal information acquired by the personal information acquiring processor; and
a transmission instructing processor that transmits, to the image communication apparatus, the instruction to transmit the document image, after the mobile communication is performed.
   (7)

The communication system according to (6),

in which the mobile terminal further includes:
a selection input interface that allows a user to select whether to perform re-communication, after the mobile communication is performed by the mobile communicator, and
a re-communication instructing processor that causes the mobile communicator to perform the re-communication, when the user selects to perform the re-communication, and

wherein the transmission instructing processor transmits, to the image communication apparatus, the instruction to transmit the document image, after the re-communication is performed.

(8)

The communication system according to (6), wherein

the address information includes a facsimile number,

the personal information includes a telephone number, and

the mobile communicator performs telephone communication on the basis of the telephone number.

(9)

The communication system according to (6), wherein the image communication apparatus makes a transition to a manual transmission mode, when the address information is transmitted to the mobile terminal by the address transmitter.

(10)

The communication system according to (8), wherein the transmission instructing processor of the mobile terminal transmits, to the image communication apparatus, the instruction to transmit the document image, when the mobile terminal on which a post-call screen is displayed is held over the image communication apparatus, the post-call screen indicating termination of the telephone communication performed by the mobile communicator.

(11)

The communication system according to (6), wherein the address transmitter of the image communication apparatus transmits the address information to the mobile terminal, when the mobile terminal is held over the image communication apparatus after the address input interface accepts the input of the address information.

(12)

The communication system according to (6), wherein

the mobile terminal further includes a transmission suspension screen display unit, the transmission suspension screen display unit displaying a transmission suspension screen when an instruction is given to suspend the instruction to transmit the document image, and

the document transmitter of the image communication apparatus suspends the transmission of the document image, when the mobile terminal on which the transmission suspension screen is displayed is held over the image communication apparatus.

(13)

The communication system according to (8), wherein

the mobile terminal further includes a post-call screen display unit, the post-call screen display unit displaying a post-call screen after a telephone call of the telephone communication performed by the mobile communicator is terminated, and

the post-call screen display unit at least displays, on the post-call screen,
a display indicating that the instruction to transmit the document image is allowed to be given by holding the mobile terminal over the image communication apparatus, and
a display directed to giving an instruction to suspend the instruction to transmit the document image.
   (14)

The communication system according to (7), wherein

the mobile terminal further includes a re-communication termination screen display unit, the re-communication termination screen display unit displaying a re-communication termination screen after the re-communication is executed, and

the re-communication termination screen display unit at least displays, on the re-communication termination screen,
a display directed to giving an instruction to discard the document image, and
a display directed to giving the instruction to transmit the document image.

According to the image communication apparatus and the communication system of one embodiment of the technology, the transmission information is received from the mobile terminal. The transmission information includes the registration information of the mobile terminal and the instruction to transmit the document image. Further, one of the document and the document image both corresponding to the registration information is determined. Further, one of the document image and the read image of the document is transmitted on the basis of the determination. Hence, it is possible to transmit a desired document image with certainty.

Each of the controller 16 illustrated in FIG. 2 and the controller 26 illustrated in FIG. 3 is implementable by circuitry that includes at least one application specific integrated circuit (ASIC), at least one semiconductor integrated circuit, and/or at least one field programmable gate array (FPGA). Non-limiting example of the at least one semiconductor integrated circuit may include at least one processor such as a central processing unit (CPU). At least one processor is configurable to perform all or a part of functions of each of the controller 16 illustrated in FIG. 2 and the controller 26 illustrated in FIG. 3, by reading instructions from at least one machine readable tangible medium. Such a medium may take many forms. Non-limiting examples of the form of such a medium may include any type of magnetic medium such as a hard disk, any type of optical medium such as a CD and a DVD, any type of semiconductor memory (i.e., semiconductor circuit) such as a volatile memory and a non-volatile memory. Non-limiting examples of the volatile memory may include a DRAM and a SRAM. Non-limiting examples of the nonvolatile memory may include a ROM and a NVRAM. The ASIC is an integrated circuit (IC) customized to perform all or a part of the functions of each of the controller 16 illustrated in FIG. 2 and the controller 26 illustrated in FIG. 3. The FPGA is an integrated circuit designed to be configured after manufacturing in order to perform all or a part of the functions of each of the controller 16 illustrated in FIG. 2 and the controller 26 illustrated in FIG. 3.

What is claimed is:

1. An image communication apparatus comprising:
a transmission information receiver that receives transmission information from a mobile terminal, the transmission information including registration information of the mobile terminal and an instruction to transmit a document image;
a document controller that determines one of a document and the document image both corresponding to the registration information, when the transmission information receiver receives the transmission information; and
a document transmitter that transmits one of the document image and a read image of the document, on a basis of the determination made by the document controller.

2. The image communication apparatus according to claim 1, further comprising:
a reader that reads the document and generates the document image; and
an image storage that stores, at least in association with the registration information, the document image generated by the reader.

3. The image communication apparatus according to claim 2, wherein the document controller determines the document image corresponding to the registration information, on a basis of information stored in the image storage.

4. The image communication apparatus according to claim 2, wherein
the transmission information receiver further receives, from the mobile terminal, personal information related to address information of the document image, and
the image storage stores the document image generated by the reader, in association with the address information, the registration information, and the personal information.

5. A communication system comprising:
a mobile terminal; and
an image communication apparatus including
a transmission information receiver that receives transmission information from the mobile terminal, the transmission information including registration information of the mobile terminal and an instruction to transmit a document image,
a document controller that determines one of a document and the document image both corresponding to the registration information, when the transmission information receiver receives the transmission information, and
a document transmitter that transmits one of the document image and a read image of the document, on a basis of the determination made by the document controller.

6. The communication system according to claim 5,
wherein the image communication apparatus further includes:
an address input interface that accepts input of address information of the document image; and
an address transmitter that transmits the address information to the mobile terminal, when the address input interface accepts the input of the address information, and
wherein the mobile terminal further includes:
a personal information storage that stores the address information and personal information related to the address information in association with each other;
an address information receiver that receives the address information from the image communication apparatus;
a personal information acquiring processor that acquires, from the personal information storage, the personal information corresponding to the address information received by the address information receiver; and
a mobile communicator that performs mobile communication based on the personal information acquired by the personal information acquiring processor; and
a transmission instructing processor that transmits, to the image communication apparatus, the instruction to transmit the document image, after the mobile communication is performed.

7. The communication system according to claim 6,
wherein the mobile terminal further includes:
a selection input interface that allows a user to select whether to perform re-communication, after the mobile communication is performed by the mobile communicator, and
a re-communication instructing processor that causes the mobile communicator to perform the re-communication, when the user selects to perform the re-communication, and
wherein the transmission instructing processor transmits, to the image communication apparatus, the instruction to transmit the document image, after the re-communication is performed.

8. The communication system according to claim 6, wherein
the address information includes a facsimile number,
the personal information includes a telephone number, and
the mobile communicator performs telephone communication on a basis of the telephone number.

9. The communication system according to claim 6, wherein the image communication apparatus makes a transition to a manual transmission mode, when the address information is transmitted to the mobile terminal by the address transmitter.

10. The communication system according to claim 8, wherein the transmission instructing processor of the mobile terminal transmits, to the image communication apparatus, the instruction to transmit the document image, when the mobile terminal on which a post-call screen is displayed is held over the image communication apparatus, the post-call screen indicating termination of the telephone communication performed by the mobile communicator.

11. The communication system according to claim 6, wherein the address transmitter of the image communication apparatus transmits the address information to the mobile terminal, when the mobile terminal is held over the image communication apparatus after the address input interface accepts the input of the address information.

12. The communication system according to claim 6, wherein
the mobile terminal further includes a transmission suspension screen display unit, the transmission suspension screen display unit displaying a transmission suspension screen when an instruction is given to suspend the instruction to transmit the document image, and
the document transmitter of the image communication apparatus suspends the transmission of the document image, when the mobile terminal on which the transmission suspension screen is displayed is held over the image communication apparatus.

13. The communication system according to claim 8, wherein
the mobile terminal further includes a post-call screen display unit, the post-call screen display unit displaying a post-call screen after a telephone call of the telephone communication performed by the mobile communicator is terminated, and
the post-call screen display unit at least displays, on the post-call screen,
a display indicating that the instruction to transmit the document image is allowed to be given by holding the mobile terminal over the image communication apparatus, and
a display directed to giving an instruction to suspend the instruction to transmit the document image.

14. The communication system according to claim 7, wherein
the mobile terminal further includes a re-communication termination screen display unit, the re-communication termination screen display unit displaying a re-communication termination screen after the re-communication is executed, and
the re-communication termination screen display unit at least displays, on the re-communication termination screen,
a display directed to giving an instruction to discard the document image, and
a display directed to giving the instruction to transmit the document image.
